(19) United States
(12) Patent Application Publication
(10) Pub. No.: US 2008/0148886 A1
(43) Pub. Date: Jun. 26, 2008

(54) Desmodromic Transmission Engine

(76) Inventors: Contardo Giovanni, Salbertrand (IT); Rubatto Giovanni, Chieri (IT)

Correspondence Address: SHELDON MAK ROSE & ANDERSON PC, 100 Corson Street, Third Floor, PASADENA, CA, 91103-3842, US

(21) Appl. No.: 11/816,390

(22) PCT Filed: Feb. 10, 2006
(86) PCT No.: PCT/IT06/00068

§ 371 Date: Aug. 15, 2007

(30) Foreign Application Priority Data
Feb. 23, 2005 (IT) TO2005A000112

(51) Int. Cl. F16H 1/28

(52) U.S. Cl. 74/89; 123/200

(57) ABSTRACT

An engine (1) is disclosed, comprising at least three, and preferably four, pistons (2) and their related cylinders (3); a rotating transmission shaft (7) having a rotation axis B-B and being equipped, at least for a certain section, with at least one cylindrical portion (8) whose rotation axis C-C is slanted with respect to such axis B-B; and at least one transmission member (9) adapted cooperate with the transmission shaft (7) next to the cylindrical portion (8) and to be connected through linkage members with each piston (2).

The present invention refers to a desmodromic transmission engine.

As widely known from the prior art, currently traditional internal combustion propulsors, being either of the otto or of the Diesel cycle, are equipped with a power transmission system of the connecting rod-crank type, such system transforming the alternate straight movement of pistons inside the cylinders into a rotary movement through a coupling between pistons and a crankshaft by interposing connecting rods. This system further provides, as known, a plurality of ball or roller bearings to allow the mutual rotation of moving parts limiting wear between parts themselves.

It is also known that the efficiency of traditional propulsors depends on a plurality of factors: one of these factors is the number of moving parts composing the power transmission system; it is clear that the greater the number of moving parts aimed to transmit power, the greater the amount of dissipated energy with a consequent decrease of global propulsor efficiency.

In parallel, it is clear that a higher number of moving parts negatively affects the global propulsor reliability.

Moreover, it is clear that the number of components composing a propulsor, in particular the power transmission system, strongly affects the propulsor production cost. In traditional propulsors, so far, it has not been possible, depending on a given desired power, to do without a certain number of pistons, connecting rods and the crankshaft; consequently, for every engine there is always a lower threshold of weights and costs below which it is not possible to go, if it is desired to keep a given reliability level almost constant.

It is evident that all manufacturers in the field of cars are interested in adopting solutions which simultaneously reduce weight and manufacturing cost of an internal combustion propulsor, keeping unchanged, if not increasing, its power and reliability.

Though the prior art has a very high number of solutions aimed to increase efficiency and reliability, to decrease costs and weights of traditional propulsors, there is nothing which provides for obtaining all these results by completely revolutioning the propulsor power transmission system architecture, namely by removing the traditional pistons—connecting rods—crankshaft transmission system.

Moreover, the prior art provides for an extremely numerous series of pneumatic, namely air-actuated, engines, whose efficiencies, always rather low, have always been related with the use of scarcely efficient architectures.

Therefore, object of the present invention is solving the above prior-art problems, by providing an internal combustion desmodromic transmission engine which can be used on any type of vehicle currently equipped with a traditional propulsor.

Another object of the present invention is providing an internal combustion desmodromic transmission engine which, by doing without the use of connecting rods and crankshaft, provides a higher efficiency than traditional propulsors.

Moreover, an object of the present invention is providing an internal combustion desmodromic transmission engine which, by doing without the use of connecting rods and crankshaft, allows a reliability increase with a simultaneous high reduction of manufacturing costs and weights with respect to traditional propulsors.

A further object of the present invention is providing a pneumatic desmodromic transmission engine characterized by a high efficiency.

The above and other objects and advantages of the invention, as will appear from the following description, are obtained by a desmodromic transmission engine as claimed in Claim 1. Preferred embodiments and non-trivial variations of the present invention are claimed in the dependent Claims.

The present invention will be better described by some preferred embodiments thereof, given as a non-limiting example, with reference to the enclosed drawings, in which:

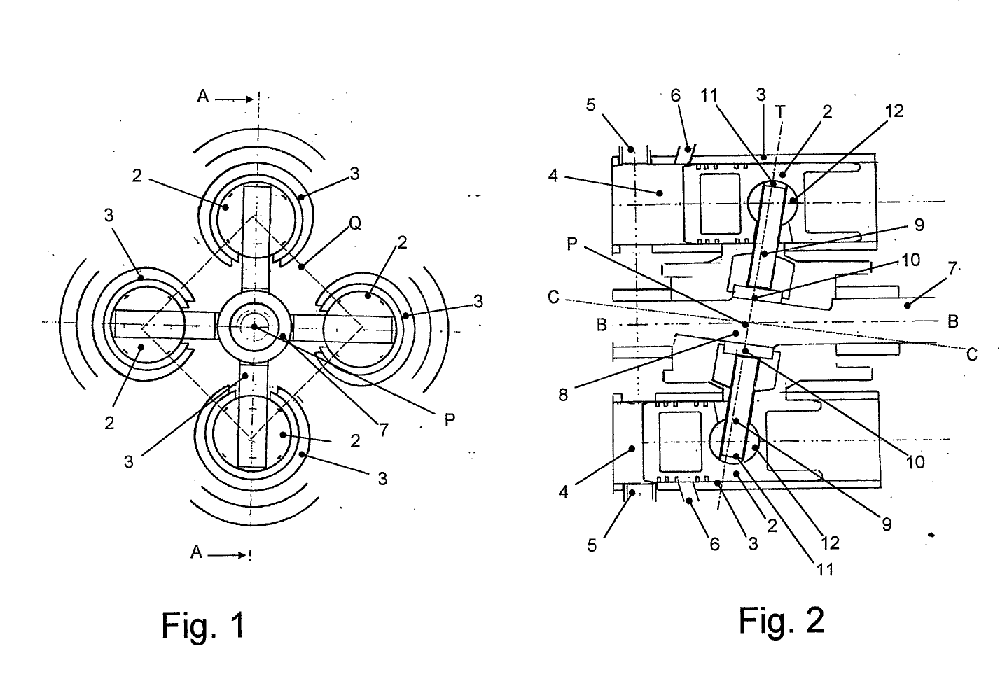

FIG. 1 shows a plan view of a preferred embodiment of the internal combustion type of the engine according to the present invention;

FIG. 2 shows a sectional view along dashed line A-A shown in FIG. 1 of an embodiment of the engine according to the present invention; and

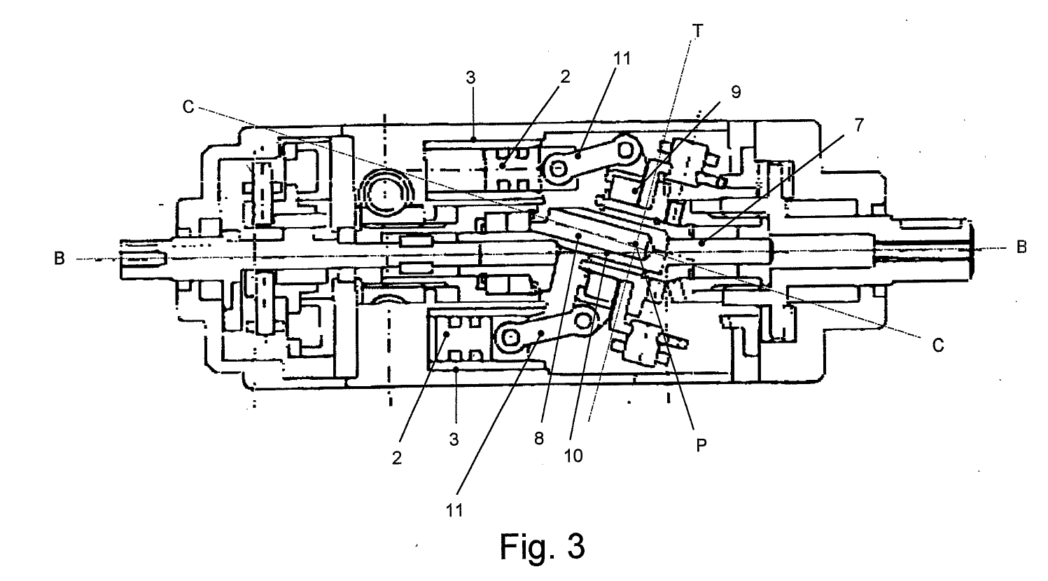

FIG. 3 shows a plan view of a preferred embodiment of the pneumatic type of the desmodromic transmission engine according to the present invention.

With reference to the Figures, it is possible to note that the desmodromic transmission engine 1 of the present invention comprises:

at least three, and preferably four, pistons 2, each piston being adapted to alternately slide in its own cylinder 3;

a rotating transmission shaft 7, adapted to be connected to the transmission system, the shaft having a rotation axis B-B and being equipped, at least for a certain section, with a cylindrical portion 8 whose rotation axis C-C is slanted with respect to axis B-B; in practice, following the rotation of the transmission shaft 7 around axis B-B, axis C-C describes a cone-shaped surface with its vertex on axis B-B;

a transmission member 9 adapted to desmodromically cooperate, preferably by interposing at least one revolving member 10 such as, for example, a roller bearing, with the transmission shaft 7 next to the cylindrical portion (8); each one of the four diametrically opposed ends of the transmission member 9 is adapted to cooperate, by interposing a linkage member 11, with a respective piston 2.

With reference in particular to FIGS. 1 and 2, it is possible to note that, in a preferred embodiment thereof of the internal combustion type, the desmodromic transmission engine 1 according to the present invention is equipped with cylinders 3, each one of which is equipped, on the combustion chamber 4 walls, with at least one entry opening 5 connected to the fuel distribution system, with at least one exhaust opening 6 connected to fume exhaust manifolds and with at least one fuel igniting means, such as for example a spark plug, connected to the supply system. It is further evident that the engine 1 according to the present invention, of the internal combustion type, is equipped with all known systems provided for managing its operation, such as an electric supply system, a fuel distribution system and a transmission system, not shown in the Figures.

Instead, with reference in particular to FIG. 3, it is possible to note a pneumatic embodiment of the engine 1 according to the present invention; in such embodiment, the movement of pistons 2 is not caused by internal combustion as in the previous embodiment, but by pneumatic thrust of a gas, preferably air, alternatively and cyclically addressed on the crown of each piston 2. Consequently, in such version of the engine 1, all previously described characteristics are superfluous, since they are exclusively dedicated to managing combustion, while compressed gas supplying means are included in each cylinder 3, together with gas expelling means from each cylinder 3 and means for managing supply and expulsion of gas, these latter ones being adapted to control the correct cyclic gas supply to all cylinders 3 and to manage the gas expelling means for guaranteeing that gas correctly goes out of each cylinder 3 during the compression step of the related piston 2.

Herein below, an embodiment of the engine 1 according to the present invention will be described, in which the cylinders 3 are preferably four: in such embodiment, each one of the cylinders 3 is arranged at a vertex of an imaginary square Q, shown in FIG. 1 with continuously dashed lines (should the cylinders 3 be three, instead of the square Q, there would be a triangle (not shown)). In the embodiment of the engine in FIG. 2, each piston 2 is connected at its own eye 12 by interposing a ball joint representing the linkage member 11, to an end of the transmission member 9. Alternatively, as shown in FIG. 3, each piston 2 can be connected to the transmission member 9 by interposing a link rod representing the linkage member 11.

In the preferred, but not limiting embodiments, the cylindrical portion 8 is obtained through surface working of the transmission shaft 7; it is however possible to obtain a similar kinematism to the one of the present invention by using a transmission shaft composed of two half-shafts having the same rotation axis B-B and interposing between them a cylindrical portion integral with them whose rotation axis C-C is slanted with respect to axis B-B.

In practice, in this preferred embodiment of the present invention, during the operation of engine 1, the coordinate movement of pistons 2 inside cylinders 3, due to the suitable management of fuel bursts determined by igniting the spark plugs inside the combustion chambers 4 or to a suitable management of gas entry and exhaust inside the cylinder 3, makes pistons 2 of each pair of diametrically opposed pistons 2 instantaneously move along the same direction but on opposite sides.

Managing of piston 2 movement must take these latter ones to sequentially move so that each piston 2 reaches its own bottom dead centre an instant after it has been reached by the piston 2 preceding it, by proceeding along the perimeter of square Q. In this way, the transmission member 9 is given an oscillating movement on many axes around a point P located by intersecting a plane T passing and parallel to the transmission member 9 and the rotation axis B-B of the transmission shaft 7.

Due to the coupling existing between transmission member 9 and cylindrical portion 8, it is unavoidable that the rotation axis C-C must always be orthogonal to plane T and therefore the oscillation of the transmission member 9 desmodromically induces the rotation of the cylindrical portion 8, consequently taking the transmission shaft 7 to rotate.

It is clear that, depending on desired transmitted power, the number of pistons 2 and cylinder 3 can be increased; pistons 2 in addition can be alternatively arranged interposing them between those already existing in the previously described preferred embodiment, by connecting them, as already described, to the transmission member 9 or pre-arranging one or more other cylindrical portions 8 of the transmission shaft 7, each one of them cooperating with a different transmission member 9 and pistons 2 assembly; in this second case, the rotation axes of the cylindrical portions will be suitably arranged with respect to the rotation axis of the transmission shaft in order to always guarantee an efficient motion transmission without failures.

It is moreover obvious that, within the scope of the present invention, it is possible to provide numerous other arrangements of cylinders and pistons whose strokes have different directions and senses with respect to those described in the previous exemplifying embodiments.

It is also obvious that the transmission shaft 7 can be supported during its rotation by revolving elements and bearing brasses (not shown).

1. A desmodromic transmission engine comprising:
at least three pistons, where each piston comprises a cylinder and where each piston is adapted to alternately slide in its own cylinder;
a rotating transmission shaft, the rotating transmission shaft having a rotation axis B-B and comprising at least one cylindrical portion whose rotation axis C-C is slanted with respect to the axis B-B; and
at least one transmission member adapted to desmodromically cooperate with the transmission shaft next to the cylindrical portion, each one of diametrically opposed ends of the transmission member being adapted to cooperate, by interposing a linkage member, with a respective piston, coordinate members of the pistons being adapted to determine a periodic oscillation on more than one axis of the transmission member, the oscillation having as fulcrum a point (P) given by an intersection between a plane T of the transmission member and the axis B-B of the transmission shaft and the axis C-C being always orthogonal to the plane T of the transmission member.

2. The engine according to claim 1, the engine being an internal combustion engine, wherein each one of the cylinders is equipped on at least one surface of a combustion chamber thereof with at least one entry opening connected to a fuel distribution system comprising fuel, with at least one exhaust opening connected to exhaust manifolds of combustion fumes and with at least one igniting means of the fuel connected to a supply system.

3. The engine according to claim 1, the engine being a pneumatic engine, wherein the engine comprises compressed gas supplying means comprising gas in each one of the cylinders, expelling means of the gas from each one of the cylinders and means for managing supply and expulsion of the gas.

4. The engine according to claim 1, that it comprises comprising at least four pistons.

5. The engine according to claim 1, wherein each one of the cylinders is arranged at a vertex of a triangle.

6. The engine according to claim 4, wherein each one of the cylinders is arranged at a vertex of a square (Q).

7. The engine according to claim 1, wherein each one of the pistons comprises an eye, and where each one of the pistons is connected in its own eye with an end of the transmission member.

8. The engine according to claim 1, wherein the transmission member desmodromically cooperates with the cylindrical portion by interposing at least one revolving member.

9. The engine according to claim 1, wherein the linkage member is a ball joint.

10. The engine according to claim 1, wherein the linkage member is a link rod.

11. The engine according to claim 1, wherein the transmission shaft comprises at least two half-shafts having a same rotation axis B-B between which at least one cylindrical portion is interposed, the cylindrical portion being integral with the half-shafts and having a rotation axis C-C which is slanted with respect to the axis B-B.

12. The engine according to claim 1, wherein the transmission shaft is supported during rotation of the transmission shaft by revolving members or by bearing brasses, or by both revolving members and bearing brasses.
